(19) United States
(12) Patent Application Publication
(10) Pub. No.: US 2020/0327493 A1
(43) Pub. Date: Oct. 15, 2020

(54) CARGO HANDLING PLACE RESERVATION SYSTEM

(71) Applicant: TOYOTA JIDOSHA KABUSHIKI KAISHA, Toyota-shi (JP)

(72) Inventors: Hiroki TABATA, Tokyo (JP); Atsushi SAJIKI, Okazaki-shi (JP); Yukio UMEMURA, Tokyo (JP); Takashi NANBU, Tokyo (JP); Kohei OHTSUKA, Tokyo (JP); Hiroki HAGIWARA, Tokyo (JP); Takeshi SAOTOME, Tokyo (JP); Masao HITOMI, Toyota-shi (JP); Yu NISHIKATA, Tokyo (JP); Kousuke MATSUYAMA, Tokyo (JP); Maiko EGUCHI, Tokyo (JP); Seiji KUROKI, Tokyo (JP); Hiroaki KAWAHARA, Tokyo (JP)

(73) Assignee: TOYOTA JIDOSHA KABUSHIKI KAISHA, Toyota-shi (JP)

(21) Appl. No.: 16/843,256

(22) Filed: Apr. 8, 2020

(30) Foreign Application Priority Data
Apr. 11, 2019 (JP) 2019-075699

(51) Int. Cl. G06Q 10/08; G06Q 10/02; G06Q 50/30; G06Q 10/06

(52) U.S. Cl. CPC G06Q 10/0836; G06Q 10/02; G06Q 50/30; G06Q 2240/00; G06Q 10/0832; G06Q 10/06312; G06Q 10/0838

(57) ABSTRACT

A cargo handling place reservation system includes a reception unit configured to receive a reservation application from a user; and a reservation unit configured to reserve a reservation target candidate place as the cargo handling place for the reservation target transportation vehicle. The reservation unit is configured to extract vacant candidate places, which are the candidate places where other reservations are not set in an allocated time slot from the expected arrival time of the reservation target transportation vehicle at the candidate place until a use time allocated to the reservation target transportation vehicle elapses, by referring to a vehicle information storage unit and a candidate place information storage unit, to determine the reservation target candidate place from the extracted vacant candidate places, and to set the reservation in the allocated time slot as the reservation status of the reservation target candidate place in the candidate place information.

### TECHNICAL FIELD

The present disclosure relates to a cargo handling place reservation system.

### CROSS-REFERENCE TO RELATED APPLICATION

This application claims the benefit of priority from Japanese Patent Application No. 2019-075699, filed Apr. 11, 2019, the entire contents of which are incorporated herein by reference.

### BACKGROUND

In the related art, a distribution center having a parking area for handling cargoes loaded in a cargo compartment of a transportation vehicle such as a truck is known (for example, refer to Japanese Unexamined Patent Publication No. 2010-152728). A driver of each transportation vehicle can perform cargo handling using the parking area provided in such a distribution center.

### SUMMARY

Incidentally, the above-described cargo handling is also required in various places other than the distribution center. For example, in some cases, at a place other than the distribution center, a driver of the transportation vehicle performs the cargo handling to take out the cargo to be delivered to a next delivery destination from the cargo compartment of the transportation vehicle. Such a cargo handling may be performed on a road or the like. In this case, there is such a risk that the transportation vehicle may block a part of the road, and hindering the surrounding traffic. Such a problem is caused by a fact that the driver of each transportation vehicle cannot properly secure a cargo handling place for performing the cargo handling at a place other than the distribution center, and uses a vacant space on the road as a cargo handling place.

Therefore, an object of the present disclosure is to provide a cargo handling place reservation system that can appropriately secure a cargo handling place for the transportation vehicle.

A cargo handling place reservation system according to an aspect of the present disclosure is a cargo handling place reservation system that reserves a cargo handling place for handling a cargo in a cargo compartment of a transportation vehicle. The system includes: a first storage unit configured to store a scheduled route information including a scheduled travel route of the transportation vehicle and an expected arrival time at each location on the scheduled travel route for each transportation vehicle; a second storage unit configured to, for each of candidate places of the cargo handling place, store a candidate place information including a position information on the candidate place and a reservation status of the candidate place; a reception unit configured to receive a reservation application from a user for the cargo handling place for a reservation target transportation vehicle; and a reservation unit configured to reserve a reservation target candidate place as the cargo handling place for the reservation target transportation vehicle. The reservation unit is configured to extract a vacant candidate place, which is the candidate place where other reservations are not set in an allocated time slot from the expected arrival time of the reservation target transportation vehicle at the candidate place until a use time allocated to the reservation target transportation vehicle elapses, by referring to the first storage unit and the second storage unit, determine the reservation target candidate place from the extracted vacant candidate places, and set the reservation in the allocated time slot as the reservation status of the reservation target candidate place in the candidate place information.

In the cargo handling place reservation system described above, when the reservation application for the reservation target transportation vehicle is received from the user, the vacant candidate places that can be used as the cargo handling place by the reservation target transportation vehicle is extracted referring to the first storage unit and the second storage unit. Then, the cargo handing place (reservation target candidate place) for the reservation target transportation vehicle is determined from the vacant candidate places. In addition, since the reservation for the reservation target transportation vehicle is set in the candidate place information on the reservation target candidate place, the reservation in the same time slot (double booking) by another transportation vehicle is reliably eliminated. As described above, according to the cargo handling place reservation system, it is possible to appropriately secure the cargo handling place for the reservation target transportation vehicle.

The scheduled route information may further include a required size information indicating a size of a space required for performing the cargo handling of the transportation vehicle. The candidate place information may further include an available size information indicating a size of a space available in the candidate place. The reservation unit may be configured to extract the vacant candidate place from the candidate places having the available size equal to or greater than the required size for the reservation target transportation vehicle. According to this, it is possible to appropriately secure the cargo handling place having a space necessary for the reservation target transportation vehicle to perform the cargo handling.

The reservation unit may be configured to notify the user of the vacant candidate places, receive a selection of the vacant candidate place by the user, and determine the vacant candidate place selected by the user as the reservation target candidate place. As a result, when there are a plurality of vacant candidate places, since a candidate place that meets the user's preference can be secured as a reservation target candidate place, the user convenience is improved.

According to the present disclosure, it is possible to provide a cargo handling place reservation system that can appropriately secure a cargo handling place for a transportation vehicle.

### BRIEF DESCRIPTION OF THE DRAWINGS

FIG. 1 is a configuration diagram of a cargo handling place reservation system according to an embodiment.

FIG. 2 is a diagram illustrating an example of vehicle information.

FIG. 3 is a diagram illustrating an example of candidate place information.

FIG. 4 is a sequence diagram illustrating an example of an operation of the cargo handling place reservation system.

### DETAILED DESCRIPTION

Hereinafter, an embodiment of the present disclosure will be described with reference to the drawings. In the drawings, the same reference signs will be given to the same or equivalent elements, and the description thereof will not be repeated.

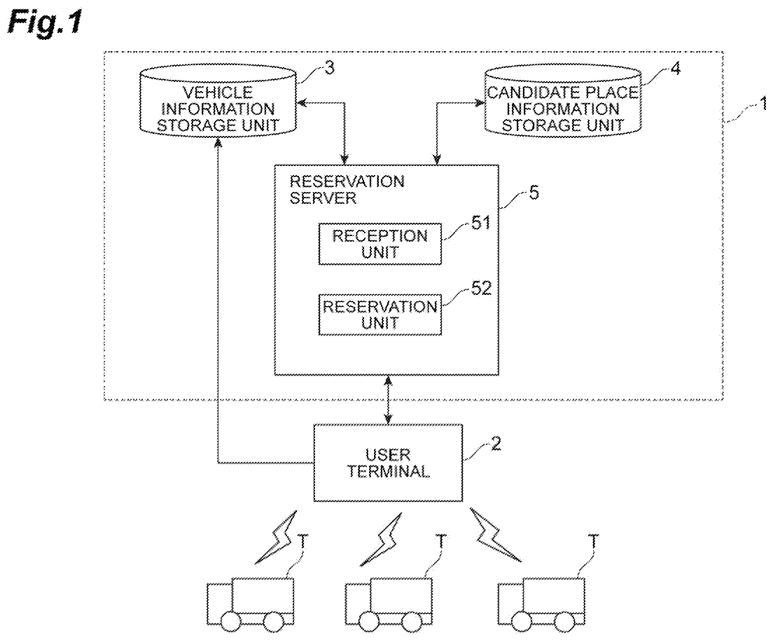

FIG. 1 is a configuration diagram of a cargo handling place reservation system 1 according to an embodiment of the present disclosure. As illustrated in FIG. 1, the cargo handling place reservation system 1 is a system that processes a reservation application to secure a cargo handling place for transportation vehicles T to be reserved, from a user terminal 2. The transportation vehicle T is, for example, a vehicle such as a truck having a cargo compartment. The cargo handling place is a place where a driver or the like of the transportation vehicle T handles the cargo in the cargo compartment. The cargo handling place includes a space for parking the transportation vehicle T and a work space for handling the cargo (e.g. a space for temporarily placing the cargo and the like). The cargo handling place reservation system 1 includes a vehicle information storage unit 3 (a first storage unit), a candidate place information storage unit 4 (a second storage unit), and a reservation server 5.

The user terminal 2 is a terminal managed by a delivery company that provides a delivery service using a plurality of transportation vehicles T, for example. The user terminal 2 is configured with a computer including a processor such as a central processing unit (CPU) and a memory such as a read only memory (ROM) or a random access memory (RAM). The user terminal 2 is operated by, for example, an operator (user) of the delivery company. For example, the operator inputs the vehicle information on each transportation vehicle T to the user terminal 2. In the present embodiment, as an example, the vehicle information includes identification information such as an identification number for identifying the transportation vehicle T, required size information indicating a size of the space required for the transportation vehicle T to perform the cargo handling, and scheduled route information of the transportation vehicle T. The scheduled route information is information including a scheduled travel route of the transportation vehicle T and an expected arrival time at each location on the scheduled travel route. The vehicle information of each transportation vehicle T input to the user terminal 2 is stored (e.g. registered) in the vehicle information storage unit 3.

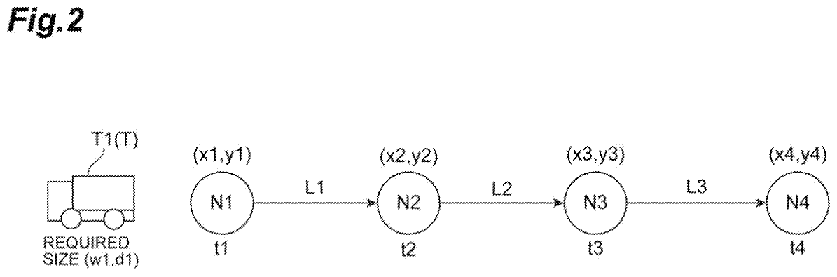

FIG. 2 is a diagram illustrating an example of the vehicle information. FIG. 2 conceptually illustrates a content of vehicle information of a certain transportation vehicle T1. As illustrated in FIG. 2, the vehicle information of the transportation vehicle T includes a width w1 and a depth d1 of the space required for the cargo handling, as the required size information indicating the size of the space required for performing the cargo handling of the transportation vehicle T1. In addition, the vehicle information includes information on a route through which the transportation vehicle travels via links L1, L2, and L3 in an order of a location N1, a location N2, a location N3, and a location N4, as the scheduled travel route of the transportation vehicle T1. Here, each of the locations N1 to N4 corresponds to a specific location such as a store or an intersection for delivering or receiving the cargo. Each of the links L1 to L3 corresponds to a road or the like used by the transportation vehicle T. Information indicating a position of each location (here, as an example, a set of latitudes and longitudes (x1, y1) to (x4, y4)) is associated with each of the locations N1 to N4. In addition, expected arrival times t1 to t4 of the transportation vehicle T1 to each location are associated with the locations N1 to N4. As described above, the scheduled route information is information indicating which route the transportation vehicle T1 is going to use, and arrives which location at what time. The number of locations and links (four locations and three links in the above example) included in the scheduled route information is not limited to the above example.

The vehicle information of each transportation vehicle T may be registered in the vehicle information storage unit 3 from the user terminal 2 at a predetermined timing (for example, a predetermined time every day). Alternatively, the user terminal 2 may collect travel information of each transportation vehicle T in real time and may also appropriately update the scheduled route information of each transportation vehicle T (especially, information on the expected arrival time associated with each location) while considering the traffic conditions (for example, traffic congestion, or the like), and then, may appropriately register the updated scheduled route information in the vehicle information storage unit 3. In this case, the scheduled route information of each transportation vehicle T according to the actual situation is stored in the vehicle information storage unit 3.

The vehicle information storage unit 3 stores the above-described vehicle information for each transportation vehicle T. Each of the user terminal 2 and the reservation server 5 are accessible to the vehicle information storage unit 3. The vehicle information storage unit 3 is, for example, a database server or the like that is communicably connected to each of the user terminal 2 and the reservation server 5 via any communication network.

The candidate place information storage unit 4 stores the candidate place information for each of the candidate places used for performing the cargo handling of the transportation vehicle T. The candidate place information storage unit 4 is, for example, a database server or the like that is communicably connected to the reservation server 5 via any communication network. In the present embodiment, as an example, the candidate place information includes position information of the candidate place, a reservation status of the candidate place, and available size information indicating a size of the space that can be used in the candidate place. Here, the candidate place is any place registered in advance as a place for performing the cargo handling of the transportation vehicle T. Specific examples of the candidate place include, for example, a space in a parking lot provided by a country or a business entity, any land (e.g. vacant land) managed by a manager of the cargo handling place reservation system 1, and the like. In addition, the candidate place may be a dedicated space provided by NEXCO, the country, a local government, or the like (for example, a space provided on a side road of an expressway or the like).

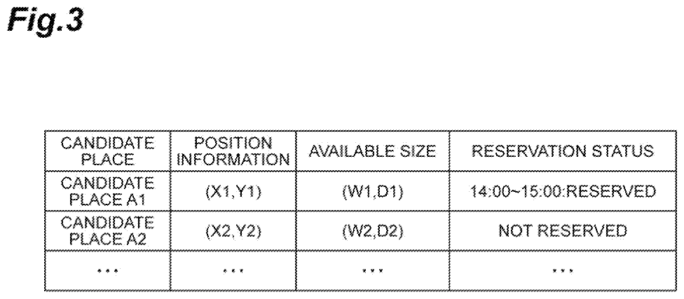

FIG. 3 is a diagram illustrating an example of the candidate place information. As illustrated in FIG. 3, the candidate place information is stored for each candidate place. In FIG. 3, the candidate place information regarding a candidate place A1 and the candidate place information regarding a candidate place A2 are illustrated.

The position information of the candidate place is represented by a set of latitude and longitude, for example. In the example in FIG. 3, a set of latitude and longitude (X1, Y1) is stored as the position information of the candidate place A1. Similarly, a set of latitude and longitude (X2, Y2) is stored as the position information of the candidate place A2.

The reservation status of the candidate place includes information indicating whether or not a reservation is made and information indicating a reserved time if the reservation is made. In the example in FIG. 3, the information indicating that a reservation is made between 14:00 and 15:00 on that day is stored as the reservation status of the candidate place A1. On the other hand, the information indicating that no reservation is made on that day (that is, the reservation is vacant in all time) is stored as the reservation status of the candidate place A2.

As the available size information of the candidate place, information on the width and the depth of the available space that can be used as the parking space and the cargo handling space is stored. In the example in FIG. 3, a set of width and depth (W1, D1) is stored as the available size information of the candidate place A1. Similarly, a set of width and depth (W2, D2) is stored as the available size information of the candidate place A2.

The reservation server 5 includes a reception unit 51 and a reservation unit 52. The reservation server 5 is configured with a computer including a processor such as a central processing unit (CPU) and a memory such as read only memory (ROM) or random access memory (RAM).

The reception unit 51 receives a reservation application for a cargo handling place for a reservation target transportation vehicle from an operator (user) of a delivery company. In the present embodiment, the reception unit 51 receives a reservation application (reservation request) from the user terminal 2. For example, a driver of each transportation vehicle T makes a reservation request for a handling place to the operator of a delivery company when the driver wants to secure the cargo handling place. The operator who received the reservation request makes a reservation application to the reservation server 5 for the cargo handling place for the transportation vehicle T (that is, the reservation target transportation vehicle) by operating the user terminal 2. In this way, the reception unit 51 receives the reservation application input to the user terminal 2.

The reservation unit 52 reserves a reservation target candidate place as a cargo handling place for the reservation target transportation vehicle. The reservation target candidate place is one of the candidate places registered in the candidate place information storage unit 4. An example of the processing by the reservation unit 52 will be described later.

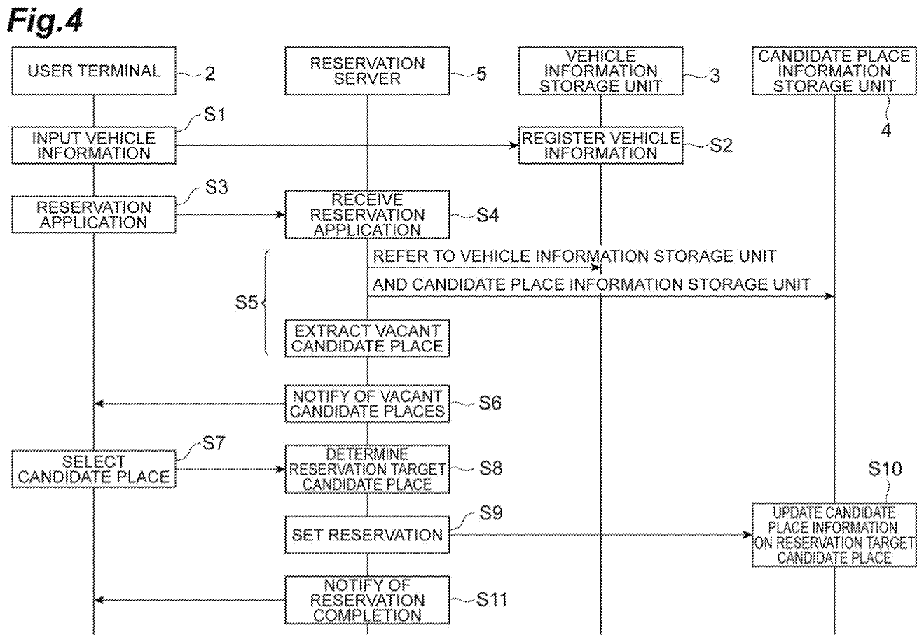

FIG. 4 is a sequence diagram illustrating an example of the operation by the cargo handling place reservation system 1. First, when the operator of the delivery company operates the user terminal 2, the vehicle information on each of the plurality of transportation vehicles T managed by the delivery company (that is, the transportation vehicles that can be reservation target by the cargo handling place reservation system 1) is input (step S1). The vehicle information on each transportation vehicle T input to the user terminal 2 is stored in the vehicle information storage unit 3 (Step S2). As described above, the registration of the vehicle information of the transportation vehicle T in the vehicle information storage unit 3 may be performed periodically at a predetermined timing. Alternatively, the vehicle information on the transportation vehicle T stored in the vehicle information storage unit 3 may be appropriately updated based on the travel state and the traffic state of the transportation vehicle T acquired in real time.

Subsequently, when the operator of the user terminal 2 receives the reservation application (for example, communication by radio or the like) from a driver of one transportation vehicle T (hereinafter, “reservation target transportation vehicle”), the operator operates the user terminal 2 to input the reservation application for the reservation target transportation vehicle (step S3). The reservation application input to the user terminal 2 is transmitted to the reservation server 5. Then, the reservation application is received by the reception unit 51 of the reservation server 5 (Step S4).

Subsequently, the reservation unit 52 extracts a vacant candidate place referring to the vehicle information storage unit 3 and the candidate place information storage unit 4 (Step S5). The vacant candidate place is a candidate place where other reservation is not set in an allocated time slot from the expected arrival time of the reservation target transportation vehicle at the candidate place until the use time allocated to the reservation target transportation vehicle elapses.

For example, the expected arrival time of the reservation target transportation vehicle at the candidate place is obtained as follows. For example, the reservation unit 52 refers to the scheduled route information of the reservation target transportation vehicle and searches for the shortest route from a predicted position of the reservation target transportation vehicle to the candidate place at a future time (for example, a time at which the completion of the reservation processing is assumed to be transmitted to the transportation vehicle T) later than the current time using a known route search algorithm. Then, the reservation unit 52 can obtain, as an expected arrival time at the candidate place, a time expected to arrive at the candidate place when the reservation target transportation vehicle heads for the candidate place using the shortest route.

In addition, the use time allocated to the reservation target transportation vehicle is a time available for performing the cargo handling of the reservation target transportation vehicle after the arrival at the candidate place. The use time described above may be determined in advance for each candidate place. Alternatively, the reservation application may include a time required for performing the cargo handling of the reservation target transportation vehicle (that is, a desired time during which the candidate place is used). In this case, the use time described above is the time included in the reservation application (that is, the time input by the operator as the time required for performing the cargo handling of the reservation target transportation vehicle).

Referring to the reservation status of the candidate place information of each candidate place stored in the candidate place information storage unit 4, the reservation unit 52 can extract a candidate place where other reservation is not set in the allocated time slot from the expected arrival time at the candidate place until the above-described use time elapses, as the vacant candidate place. That is, a candidate place where other reservation is not set in the time slot during which the reservation target transportation vehicle is expected to use the candidate place can be extracted as the reservation candidate (vacant candidate place) for the cargo handling place of the reservation target transportation vehicle.

In the present embodiment, the reservation unit 52 further extracts the candidate places that satisfy the following conditions as the vacant candidate places. That is, the reservation unit 52 extracts the vacant candidate places from the candidate places having an available size equal to or larger than the required size of the reservation target transportation vehicle. In the present embodiment, the reservation unit 52 extracts the vacant candidate places from the candidate places of which the width of the available size is equal to or greater than a width of the required size of the reservation target transportation vehicle, and of which the depth of the available size is equal to or greater than a depth of the required size of the reservation target transportation vehicle. In this way, it is possible to appropriately extract only the reservation target candidate places having the space necessary for performing the cargo handling of the reservation target transportation vehicle.

By the processing by the reservation unit 52 described above, the candidate places that satisfies both a first condition that other reservation is not set in the allocated time slot and a second condition that the candidate places has the available size equal to or greater than the required size of the reservation target transportation vehicle, can be extracted as the vacant candidate place. The reservable candidate places are extracted by using the first condition, and the candidate places where the cargo handling of the reservation target transportation vehicle can be performed are extracted by using the second condition. Therefore, by extracting the candidate places that satisfy the above-described two conditions, the reservable candidate places where the cargo handling of the reservation target transportation vehicle can be performed can be extracted as the vacant candidate place.

Subsequently, the reservation unit 52 notifies the user terminal 2 of the one or more vacant candidate places extracted as described above (Step S6). Here, if there is no available vacant candidate place, the reservation unit 52 notifies the user terminal 2 of that result. In this case, the subsequent reservation processing is not performed. On the other hand, if a plurality of vacant candidate places are extracted, the reservation unit 52 may, for example, present the plurality of vacant candidate places to the user in an ascending order of travel distance of the travel route of the reservation target transportation vehicle, which is changed by the reservation target transportation vehicle passing through the vacant candidate places. In this way, it is possible to preferentially present a vacant candidate places that are preferable for the driver of the transportation vehicle T (that is, the vacant candidate places that can minimize a time loss caused by passing through the vacant candidate places).

Subsequently, the operator of the delivery company who confirmed the one or more vacant candidate places notified to the user terminal 2, determines a vacant candidate place to be secured as the cargo handling place by appropriately contacting the driver of the reservation target transportation vehicle. Then, the operator inputs a selection of a vacant candidate place to be secured as the cargo handling place via the user terminal 2 (step S7).

Subsequently, the reservation unit 52 receives the selection of the vacant candidate place input to the user terminal 2, and determines the vacant candidate place selected by the operator as a reservation target candidate place (step S8). Then, the reservation unit 52 sets the reservation for the reservation target transportation vehicle in the allocated time slot as the reservation status of the candidate place information on the reservation target candidate place (step S9). For example, if the time slot allocated to the reservation target transportation vehicle is 1 hour from 16:00 to 17:00, information indicating that a reservation is set in the time slot from 16:00 to 17:00 is stored as the reservation status of the candidate place information on the reservation target candidate place. That is, the content of the reservation status of the candidate place information on the reservation target candidate place, which is stored in the candidate place information storage unit 4, is updated as described above (step S10).

Subsequently, the reservation unit 52 notifies the user terminal 2 that the reservation of the reservation target candidate place is completed (Step S11). As described above, a series of reservation processing by the cargo handling place reservation system 1 is completed.

In the cargo handling place reservation system 1 described above, when a reservation application for a reservation target transportation vehicle is received from a user (in this embodiment, an operator of a delivery company using the user terminal 2), a vacant candidate place that can be used as the cargo handling place by the reservation target transportation vehicle is extracted referring to the vehicle information storage unit 3 and the candidate place information storage unit 4. That is, the reservation unit 52 automatically extracts the vacant candidate place based on the vehicle information on the reservation target transportation vehicle and the candidate place information on each candidate place. This eliminates the need for the user to manually search for a vacant candidate place, and high convenience for the user is realized. Then, a cargo handing place (reservation target candidate place) for the reservation target transportation vehicle is determined from the vacant candidate places. In addition, since the reservation for the reservation target transportation vehicle is set in the candidate place information on the reservation target candidate place, the reservation in the same time slot (double booking) by another transportation vehicle T is reliably eliminated. As described above, according to the cargo handling place reservation system 1, it is possible to appropriately secure a cargo handling place for the reservation target transportation vehicle.

In addition, the scheduled route information includes required size information indicating a size of a space required for the cargo handling of the transportation vehicle T, and the candidate place information includes available size information indicating a size of a space that can be used in the candidate place. Then, the reservation unit 52 extracts a vacant candidate place from the candidate places having the available size equal to or greater than the required size for the reservation target transportation vehicle. As a result, it is possible to appropriately secure a cargo handling place having a space required for performing the cargo handling of the reservation target transportation vehicle.

In addition, the reservation unit 52 notifies the user of the vacant candidate place, receives the selection of the vacant candidate place from the user, and determines the vacant candidate place selected by the user as the reservation target candidate place. As a result, when there are a plurality of vacant candidate places, since a candidate place that meets the user's preference can be secured as a reservation target candidate place, the user convenience is improved.

As described above, an embodiment of the present disclosure is described, but the present disclosure is not limited to the above-described embodiment. The present disclosure can be implemented in various modifications without departing from the gist of the aspects.

For example, operators (user terminals 2) of a plurality of different delivery companies may access the cargo handling place reservation system 1. That is, the cargo handling place reservation system 1 may be a system that can be used by a plurality of different delivery companies.

In addition, in the above embodiment, the operator of the delivery company operates the user terminal 2 as a user, but the user terminal 2 may be a vehicle-mounted terminal mounted on each transportation vehicle T. In this case, the driver of each transportation vehicle T can perform the reservation application by directly accessing the cargo handling place reservation system 1 (the vehicle information storage unit 3 and the reservation server 5) without using the operator of the delivery company. In this case, the driver of each transportation vehicle T may be a user of the cargo handling place reservation system 1.

In addition, in the embodiment described above, when a plurality of vacant candidate places are extracted, the reservation unit 52 notifies the user of the plurality of vacant candidate places and determines the vacant candidate place selected by the user as a reservation target candidate place, however, the notification of the vacant candidate place to the user may be omitted. That is, in the example in FIG. 4, steps S6 and S7 may be omitted. In this case, for example, the reservation unit 52 may determine the best vacant candidate place as the reservation target candidate place based on a criterion set in advance by the user. For example, a criterion such as an order of lowest usage fee or an order of lowest transit cost of the candidate place (that is, the time loss caused by passing through the candidate place) can be used as the criterion.

What is claimed is:

1. A cargo handling place reservation system that reserves a cargo handling place for handling a cargo in a cargo compartment of a transportation vehicle, comprising:
a first storage unit configured to store a scheduled route information including a scheduled travel route of the transportation vehicle and an expected arrival time at each location on the scheduled travel route for each transportation vehicle;
a second storage unit configured, for each of candidate place of the cargo handling place, to store a candidate place information including a position information on the candidate place and a reservation status of the candidate place;
a reception unit configured to receive a reservation application from a user for the cargo handling place for a reservation target transportation vehicle; and
a reservation unit configured to reserve a reservation target candidate place as the cargo handling place for the reservation target transportation vehicle,
wherein the reservation unit is configured to
extract a vacant candidate place, which is the candidate place where other reservations are not set in an allocated time slot from the expected arrival time of the reservation target transportation vehicle at the candidate place until a use time allocated to the reservation target transportation vehicle elapses, by referring to the first storage unit and the second storage unit,
determine the reservation target candidate place from the extracted vacant candidate places, and
set the reservation in the allocated time slot as the reservation status of the reservation target candidate place in the candidate place information.

2. The cargo handling place reservation system according to claim 1,
wherein the scheduled route information further includes a required size information indicating a size of a space required for performing the cargo handling of the transportation vehicle,
wherein the candidate place information further includes an available size information indicating a size of space available in the candidate place, and
wherein the reservation unit is configured to extract the vacant candidate place from the candidate places having the available size equal to or greater than the required size for the reservation target transportation vehicle.

3. The cargo handling place reservation system according to claim 1,
wherein the reservation unit is configured to notify the user of the vacant candidate places, receive a selection of the vacant candidate place by the user, and determine the vacant candidate place selected by the user as the reservation target candidate place.

4. The cargo handling place reservation system according to claim 2,
wherein the reservation unit is configured to notify the user of the vacant candidate places, receive a selection of the vacant candidate place by the user, and determine the vacant candidate place selected by the user as the reservation target candidate place.
